(19) United States
(12) Patent Application Publication
(10) Pub. No.: US 2015/0169310 A1
(43) Pub. Date: Jun. 18, 2015

(54) MAINTAINING FIRMWARE

(71) Applicant: LENOVO (Singapore) PTE, LTD., New Tech Park (SG)

(72) Inventors: Jennifer Lee-Baron, Morrisville, NC (US); John Scott Crowe, Durham, NC (US); Nathan J. Peterson, Durham, NC (US); Amy Leigh Rose, Chapel Hill, NC (US)

(73) Assignee: LENOVO (Singapore) PTE, LTD., New Tech Park (SG)

(21) Appl. No.: 14/104,879

(22) Filed: Dec. 12, 2013

(51) Int. Cl. G06F 9/445

(52) U.S. Cl. CPC G06F 8/65

(57) ABSTRACT

For maintaining firmware, a firmware module determines whether installed firmware for a device matches firmware information during a boot of the device. The firmware information may be stored at a specified storage location. A management module mitigates a difference between the installed firmware and the firmware information.

### BACKGROUND

1. Field

The subject matter disclosed herein relates to firmware and more particularly relates to maintaining firmware.

2. Description of the Related Art

Electronic devices often employ firmware. Firmware may be periodically updated. However, the firmware updates may be lost when electronic device is replaced.

### BRIEF SUMMARY

An apparatus for maintaining firmware is disclosed. The apparatus includes a processor and a memory storing code. The code includes a firmware module and a management module. The firmware module determines whether installed firmware for a device matches firmware information during a boot of the device. The firmware information may be stored at a specified storage location. The management module mitigates a difference between the installed firmware and the firmware information. A method and program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of an electronic device;

FIG. 1B is a schematic block diagram illustrating one alternate embodiment of an electronic device;

FIG. 2A is a schematic block diagram illustrating one embodiment of a firmware information;

FIG. 2B is a schematic block diagram illustrating one alternate embodiment of firmware information;

FIG. 3A is a schematic block diagram illustrating one embodiment of a baseboard management controller;

FIG. 3B is a schematic block diagram illustrating one embodiment of a firmware maintenance apparatus;

FIG. 4 is a schematic flow chart diagram illustrating one embodiment of a firmware maintenance method; and

FIG. 5 is a schematic flow chart diagram illustrating one embodiment of a firmware mitigation method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

Descriptions of Figures may refer to elements described in previous Figures, like numbers referring to like elements.

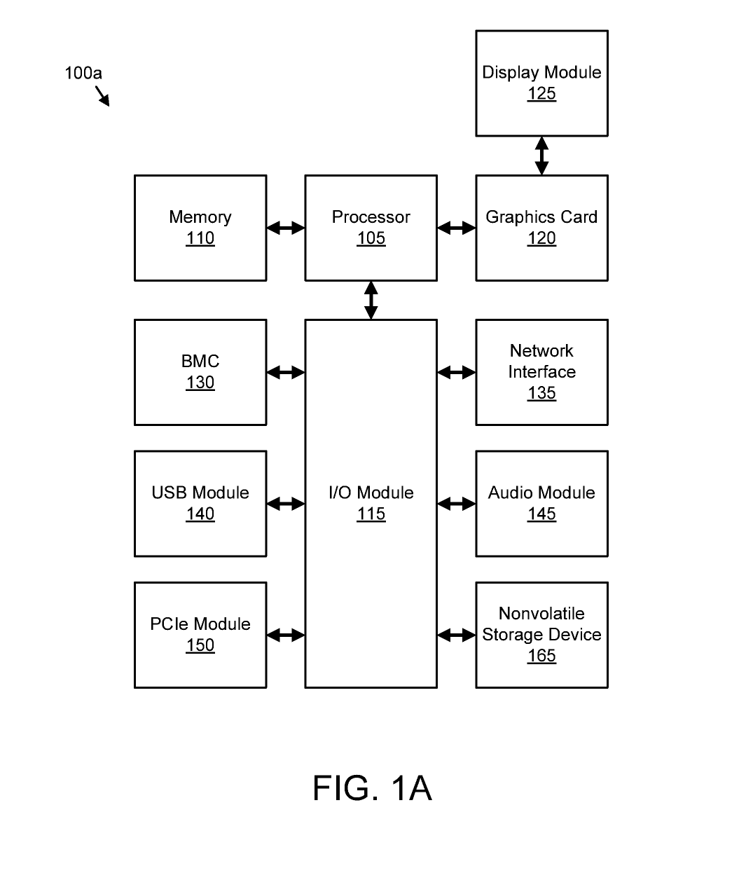

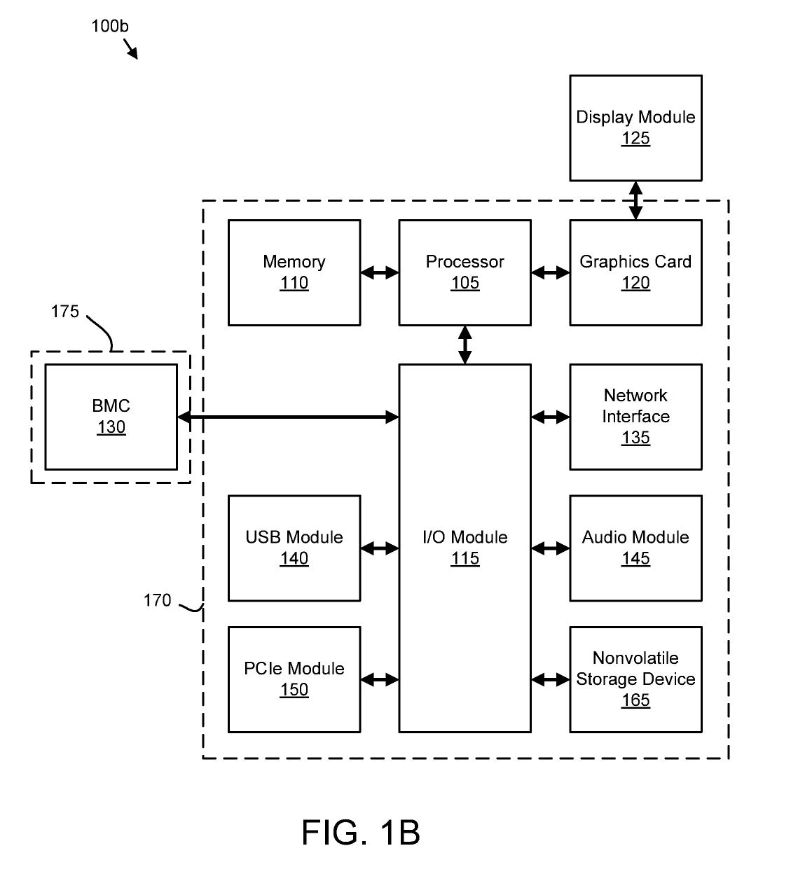

FIG. 1A is a schematic block diagram illustrating one embodiment of an electronic device 100a. The electronic device 100a may be a mainframe computer, a server, a computer workstation, a laptop computer, tablet computer, a communications device, or the like. The electronic device 100a includes a processor 105, a memory 110, an input/output (I/O) module 115, a graphics card 120, a display module 125, a baseboard management controller (BMC) 130, a network interface 135, a Universal Serial Bus (USB) module 140, an audio module 145, a Peripheral Component Interconnect Express (PCIe) module 150, and a nonvolatile storage device 165, referred to herein as components.

The memory 110 may be a semiconductor storage device, a hard disk drive, an optical storage device, a micromechanical storage device, or combinations thereof. The memory 110 may store code. The processor 105 may execute the code.

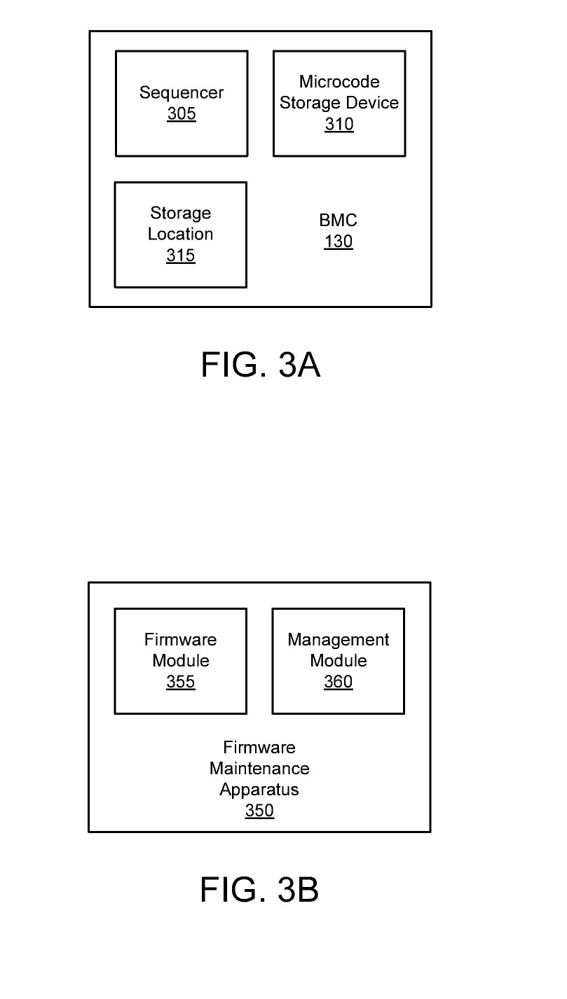

The BMC 130 may include a microcontroller that executes code stored in the microcode storage device as will be described hereafter in FIG. 3A. In one embodiment, the BMC 130 may monitor the function of the electronic device 100a. The BMC 130 may include a storage location for storing the firmware information.

The graphics card 120 may provide graphic images for the display module 125. The graphics card 120 may include graphics card firmware stored in a storage device. The graphics card firmware may be periodically updated.

The network interface 135 may communicate with one or more networks. The networks may include but are not limited to the Internet, a mobile telephone network, a Wi-Fi network, Bluetooth network, a wide area network, and/or a local area network. The network interface 135 may also include network interface firmware stored in a storage device. The network interface firmware may also be periodically updated.

The audio module 145 may generate an audio output signal. The audio module 145 may include audio module firmware stored in a storage device. The audio module firmware may be periodically updated. The USB module 140 may interface through USB connections to one or more USB compatible devices. The USB module 140 may also store USB module firmware in a storage device. The USB module firmware may also be periodically updated.

The PCIe module 150 may interface with PCIe compatible cards. The PCIe module 150 may include PCIe module firmware stored in a storage device. The PCIe module firmware may be periodically updated.

The nonvolatile storage device 165 may be a redundant array of independent drives (RAID) device, a hard disk drive, an optical storage device, a micromechanical storage device, a semiconductor storage device, or combinations thereof. The nonvolatile storage device 165 may include storage device firmware. The storage device firmware may be stored on the nonvolatile storage device 165 and/or on a semiconductor storage device of the nonvolatile storage device 165. The storage device firmware may also be periodically updated.

A component of the electronic device 100a may periodically fail. In response to the failure, the component may be replaced to restore functionality to the electronic device 100a. For example, the network interface 135 may fail and a technician and/or user may replace the original network interface 135 with a replacement network interface 135.

Unfortunately, when a component is replaced, the replacement component may not include firmware that has been updated to the same version level as the firmware of the original component. As a result, although the hardware of the replacement component is typically fully functional, the down level firmware of the replacement component may degrade the performance of the replacement component or the electronic device 100a, or may prevent the function of the component or electronic device 100a altogether. Often, the degraded performance or failure of the replacement component is difficult to diagnose, resulting in increased service costs.

The embodiments described herein determine whether installed firmware for a device such as the electronic device 100a and/or a component of the electronic device 100a matches firmware information during a boot of the device. In addition, the embodiments mitigate the difference between the installed firmware and the firmware information as will be described hereafter. As a result, when replacement component is installed in the electronic device 100a, the firmware may be updated to the same version level as the firmware of the original component, reducing firmware related problems.

FIG. 1B is a schematic block diagram illustrating one alternate embodiment of an electronic device 100b. The components of the electronic device 100a of FIG. 1 are shown. However, in the depicted embodiment, the processor 105, the memory 110, the I/O module 115, the graphics card 120, the network interface 135, the USB module 140, the audio module 145, the PCIe module 150, and the nonvolatile storage device 165 may be disposed wholly or in part on a motherboard 170.

For example, the nonvolatile storage device 165 may include an interface disposed on the motherboard 170 and a hard disk drive connected to the motherboard 170 through cable to the interface. The BMC 130 may be disposed on a plug-in card 175 that communicates with the motherboard 170.

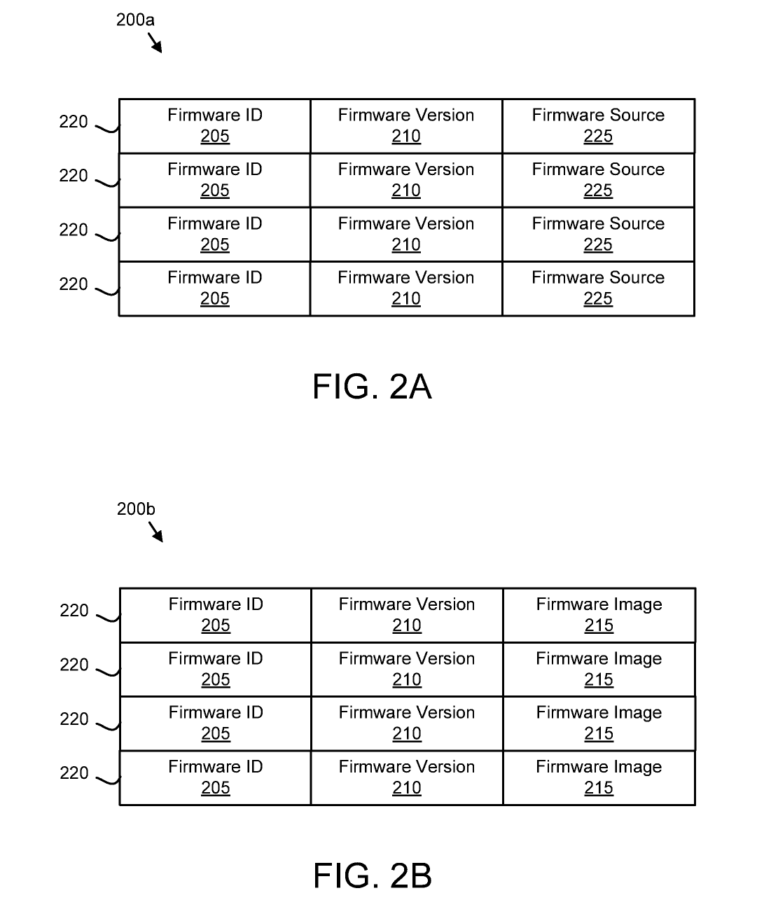

FIG. 2A is a schematic block diagram illustrating one embodiment of firmware information 200a. The firmware information 200a may describe the firmware of the electronic device 100. The firmware information 200a may be stored in a specified storage location. The specified storage location may be one or more of a BMC storage location, a nonvolatile semiconductor storage location, a hard disk drive storage location, and a network allocated storage location.

The firmware information 200a may be organized as a database, linked data structures, a flat file, or combinations thereof. In the depicted embodiment, the firmware information 200a includes a plurality of entries 220. Each entry 220 may include a firmware identifier 205, a firmware version 210, and a firmware source 225.

The firmware identifier 205 may uniquely identify the firmware associated with the entry 220. The firmware identifier 205 may be an identification string, a logical name of the firmware, or combinations thereof.

The firmware version 210 may identify a version of the firmware associated with the entry 220. The firmware version 210 may be a timestamp, a version number, or combinations thereof. In addition, the firmware version 210 may include an installed flag. The installed flag may indicate that the firmware version 210 of the entry 220 is currently installed.

The firmware source 225 may identify a source of the firmware associated with the entry 220. The firmware source 225 may be a Universal Resource Locator (URL) where an image of the firmware resides. Alternatively, the firmware source 225 may be a memory location within the electronic device 100 where an image of the firmware is stored. In one embodiment, the firmware source 225 includes credentials that may be used to retrieve and/or install the image of the firmware. For example, the credentials may include an account name, password, a license key, or combinations thereof.

In one embodiment, the firmware of the electronic device 100 and/or component of the electronic device 100 may be updated by retrieving a firmware image that is identified by the firmware identifier 205 and the firmware version 210 from the location specified by the firmware source 225. The retrieved image may further be installed.

FIG. 2B is a schematic block diagram illustrating one alternate embodiment of the firmware information 200b. The firmware information 200b may describe the firmware of the electronic device 100. The firmware information 200b may be stored in a specified storage location. The specified storage location may be one or more of a BMC storage location, a nonvolatile semiconductor storage location, a hard disk drive storage location, and a network allocated storage location.

The firmware information 200b may be organized as a database, linked data structures, a flat file, or combinations thereof. In the depicted embodiment, the firmware information 200b includes a plurality of entries 220. Each entry 220 may includes the firmware identifier 205, the firmware version 210, and a firmware image 215.

The firmware image 215 may be the image of the firmware associated with the entry 220. Firmware of the electronic device 100 and/or component of the electronic device 100 may be updated by installing the firmware image 215.

FIG. 3A is a schematic block diagram illustrating one embodiment of the BMC 130. The BMC 130 may include a sequencer 305, a microcode storage device 310, and a storage location 315. The microcode storage device 310 may store code that may be executed by the sequencer 305. The storage location 315 may store the firmware information 200.

In one embodiment, the BMC 130 manages the firmware of the electronic device 100 and/or components of the electronic device 100. For example, the BMC 130 may record the firmware information 200 for each installation of a firmware image 215. In addition, the BMC 130 may determine whether installed firmware for a device matches firmware information during a boot of the device. The BMC 130 may further mitigate a difference between the installed firmware and the firmware information.

FIG. 3B is a schematic block diagram illustrating one embodiment of a firmware maintenance apparatus 350. The apparatus 350 may be embodied in the electronic device 100, the BMC 130, or combinations thereof. The apparatus 350 may include a firmware module 355 and a management module 360. The firmware module 355 and the management module 360 may be embodied in a computer readable storage device such as the memory 110 and/or the microcode storage device 310. The computer readable storage device may store code that is executable by the processor 105 and/or sequencer 305.

The firmware module 355 may determined whether installed firmware for a device such as the electronic device 100 or a component of the electronic device 100 matches the firmware information 200 during a boot of the device. The management module 360 may mitigate the difference between the installed firmware and the firmware information 200 as will be described hereafter.

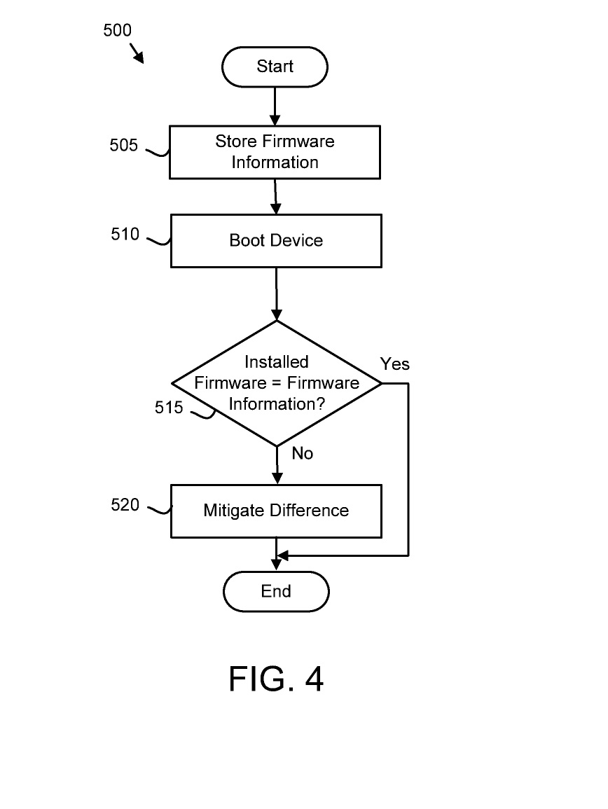

FIG. 4 is a schematic flow chart diagram illustrating one embodiment of a firmware maintenance method 500. The method 500 may perform the functions of the electronic device 100, the BMC 130, and/or the firmware maintenance apparatus 350. In one embodiment, the method 500 is performed by a processor such as the processor 105 of the electronic device 100 and/or the sequencer 305 of the BMC 130. Alternatively, the method 500 may be embodied in a program product. The program product may include a computer readable storage medium such as the memory 110 and/or microcode storage device 310. The computer readable storage media may store code that when executed by a processor performs the functions of the method 500.

The method 500 starts, and in one embodiment, the firmware module 355 stores 505 the firmware information 200. The firmware module 355 may be embodied in the electronic device 100, the BMC 130, or combinations thereof. In one embodiment, the firmware module 355 records the firmware information 200 for each installation of a firmware image. For example, if an update to the storage device firmware is installed, the firmware identifier 205 and the firmware version 210 for the update may be recorded in the firmware information 200.

In addition, the image of the update may be recorded in the firmware image 215. Alternatively, the source of the image for the update may be recorded in the firmware source 225.

In one embodiment, a new entry 220 to the firmware information 200 is added each time firmware is installed. For example, if the storage device firmware is updated by installing a 2.0 version of the storage device firmware in place of a 1.0 version of the storage device firmware, the entry 220 for the 1.0 version of the storage device firmware may remain in the firmware information 200 while a new entry 220 for the 2.0 version of the storage device firmware is added to the firmware information 200.

Alternatively, the firmware for each device may have a single entry 220 in the firmware information 200. In addition, when firmware is updated by installing another version of the firmware, the entry 220 for the firmware may be overwritten with the new information. For example, if the storage device firmware is updated by installing the 2.0 version of the storage device firmware in place of the 1.0 version of the storage device firmware, the entry 220 for the 1.0 version of the storage device firmware may be overwritten with the new firmware identifier 205, firmware version 210, the firmware source 225, and/or the firmware image 215.

The firmware information 200 may be stored 505 at a specified storage location. The specified storage location maybe one or more of the storage location 315 of the BMC 130, a hard disk drive storage location of the nonvolatile storage device 165, and a network allocated storage location accessible through the network interface 135.

By storing the firmware information 200 at the specified storage location, the firmware information 200 is available even if significant components of the electronic device 100 are replaced. For example, if the firmware information 200 is stored on the storage location 315 of the BMC 130 and the BMC 130 is disposed on a plug-in card 175, the original motherboard 170 may be replaced with replacement motherboard 170 and the plug-in card 175 reconnected to the replacement motherboard 170. As a result, the firmware information 200 remains available even though much of the hardware of the electronic device 100 was replaced.

The device may further boot 510. The device may be the electronic device 100. Alternatively, the device may be a component of the electronic device 100. The boot may be in response to powering on the device, resetting the device, or combinations thereof.

In one embodiment, the boot 510 of the device may be subsequent to installing a replacement device. For example, the original network interface 135 may have been replaced with a replacement network interface 135. Alternatively, the original motherboard 170 of the electronic device 100 may have been replaced with a replacement motherboard 170. In addition, the original plug-in card 175 containing the BMC 130 may have been retained and reinstalled on the replacement motherboard 170.

The firmware module 355 may determine 515 whether the installed firmware for the device matches the firmware information 200 during the boot 510 of the device. The firmware module 355 may retrieve the firmware identifier and/or firmware version from the installed firmware of the device during the boot 510 of the device. In one embodiment, the firmware module 355 uses the firmware identifier of the installed firmware as an index to find one or more entries 220 for the installed firmware in the firmware information 200.

In one embodiment, the firmware module 355 employs the entry 220 from the firmware information 200 with a firmware identifier 205 that corresponds to the firmware identifier of the installed firmware and that has the highest firmware version 210. Alternatively, the firmware module 355 employs the entry 220 from the firmware information 200 with the firmware identifier 205 it corresponds to the firmware identifier of the installed firmware and that has the latest timestamp.

The firmware module 355 may further compare the firmware identifier and/or firmware version from the installed firmware with the firmware identifier 205 and/or firmware version 210 recorded in the firmware information 200. In one embodiment, if the firmware version from the installed firmware matches the firmware version 210 record in the firmware information 200, the installed firmware for the device matches the firmware information 200.

In an alternative embodiment, the firmware module 355 may compare the installed firmware with a firmware image 215 stored in the firmware information 200. If the installed firmware matches the firmware image 215, the firmware module 355 may determine 515 that installed firmware for the device matches the firmware information 200.

If the installed firmware matches the firmware information 200, the method 500 may end. Alternatively, if the installed firmware does not match the firmware information 200, the management module 360 may mitigate 520 the difference between the installed firmware and the firmware information 200 and the method 500 ends.

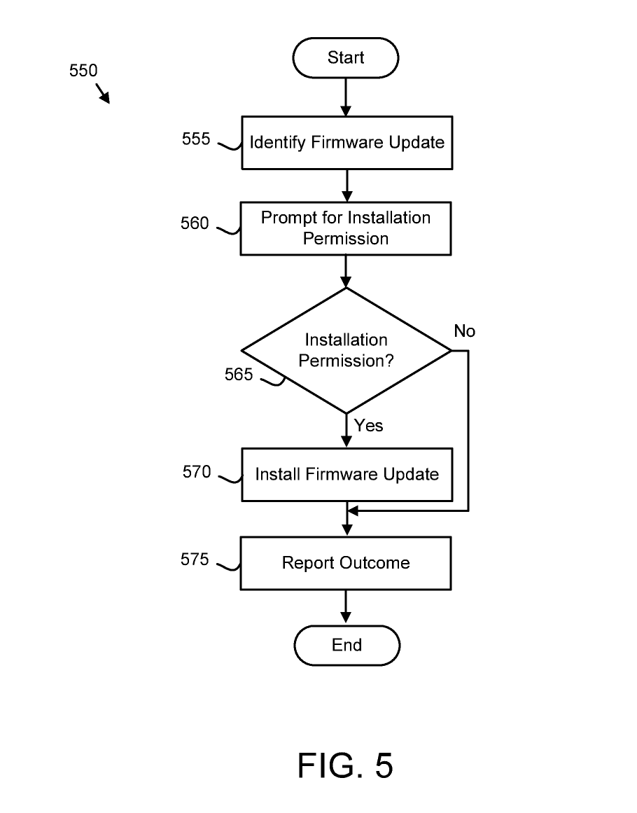

The management module 360 may mitigate 520 the difference between the installed firmware and the firmware information 200 by updating the firmware of the device to be equivalent to the firmware information 200. The updating of the firmware is described in more detail in the description of FIG. 5.

FIG. 5 is a schematic flow chart diagram illustrating one embodiment of a firmware mitigation method 550. The method 550 may perform the functions of the electronic device 100, the BMC 130, and/or the firmware maintenance apparatus 350. In one embodiment, the method 550 is performed by a processor such as the processor 105 of the electronic device 100 and/or the sequencer 305 of the BMC 130. Alternatively, the method 550 may be embodied in a program product. The program product may include a computer readable storage medium such as the memory 110 and/or microcode storage device 310. The computer readable storage media may store code that when executed by a processor performs the functions of the method 550.

The method 550 starts, and in one embodiment, the management module 360 identifies 555 a firmware update from an entry 220 of the firmware information 200. In one embodiment, the firmware update is the firmware last installed for an original device that has been replaced by replacement device.

Alternatively, the management module 360 may identify 555 a firmware update for the device that is compatible with other firmware installed on the electronic device 100 and described in the firmware information 200. For example, if the motherboard 170 of the electronic device 100 is replaced, the storage device firmware of a RAID device in communication with the replacement motherboard 170 may require a firmware update in order to be compatible with the replacement motherboard 170.

In one embodiment, the management module 360 may identify 555 the firmware update for the device by comparing the firmware information 200 with a remote repository detailing firmware configurations. The management module 360 may further retrieve the firmware update for the device from the remote repository.

The management module 360 may prompt 560 for an installation permission to install the firmware update. A user may be prompted 560 through an on-screen display as is well known to those of skill in the art. Alternatively, a management program may be prompted 560 for the installation permission. In one embodiment, the installation permission may be automatically granted.

If the management module 360 does not receive an installation permission 565 in response to the prompt 560, the management module 360 may report 575 the outcome and the method 550 ends. For example, the management module 360 may report 575 that a firmware update was identifying but not installed because no installation permission was received. The management module 360 may report 575 the outcome to a display, a log file, an administrator, or combinations thereof.

If the management module 360 receives the installation permission 565, the management module 360 may install 570 the firmware update. In one embodiment, the management module 360 receives the installation permission 565 in response to the prompt 560.

The management module 360 may retrieve an image for the firmware update from the firmware source 225. Alternatively, the management module 360 may use the firmware image 215 stored in the firmware information 200. The management module 360 may install 570 the firmware update by installing the image as is well known to those of skill in the art.

In one embodiment, the management module 360 sets the installed flag of the firmware version 210 for the firmware in response to successfully installing 570 the firmware update. However, if the management module 360 is unable to successfully install 570 the firmware update, the management module 360 may clear the installed flag.

The management module 360 may further report 575 the outcome. In one embodiment, the management module 360 may report that the firmware update was identified, that the installation permission was received, and that the firmware update was installed successfully. Alternatively, the management module 360 may report 575 that the firmware update was identified, that the installation permission was received, and that the firmware update was not successfully installed.

By determining whether installed firmware for a device matches the firmware information 200 during a boot of the device and mitigating any differences between the installed firmware and the firmware information 200, the embodiments provide that the firmware for replacement devices may be updated to the firmware version 210 of the original devices. As a result, replacement devices will not have degraded performance or fail because the firmware of the replace device is different from the firmware of the original device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor, the code comprising:
a firmware module that determines whether installed firmware for a device matches firmware information during a boot of the device, wherein the firmware information is stored at a specified storage location; and
a management module that mitigates a difference between the installed firmware and the firmware information.

2. The apparatus of claim 1, wherein the management module mitigates the difference by:
identifying a firmware update; and
installing the firmware update.

3. The apparatus of claim 2, wherein the firmware update is installed in response to an installation permission.

4. The apparatus of claim 1, wherein the firmware module further records the firmware information for each installation of a firmware image.

5. The apparatus of claim 1, wherein the firmware information comprises a firmware identifier and a firmware version.

6. The apparatus of claim 1, wherein the specified storage location is one or more of a baseboard management controller storage location, a nonvolatile semiconductor storage location, a hard disk drive storage location, and a network allocated storage location.

7. The apparatus of claim 1, wherein the device is one or more of a computer, a redundant array of independent drives (RAID) device, a network interface, a hard disk drive, a graphics card, and a baseboard management controller.

8. A method comprising:
determining, by use of a processor, whether installed firmware for a device matches firmware information during a boot of the device, wherein the firmware information is stored at a specified storage location; and
mitigating a difference between the installed firmware and the firmware information.

9. The method of claim 8, wherein mitigating the difference comprises:
identifying a firmware update; and
installing the firmware update.

10. The method of claim 9, wherein the firmware update is installed in response to an installation permission.

11. The method of claim 8, the method further comprising recording the firmware information for each installation of a firmware image.

12. The method of claim 8, wherein the firmware information comprises a firmware identifier and a firmware version.

13. The method of claim 8, wherein the firmware information comprises a firmware image.

14. The method of claim 8, wherein the specified storage location is one or more of a baseboard management controller storage location, a nonvolatile semiconductor storage location, a hard disk drive storage location, and a network allocated storage location.

15. The method of claim 8, wherein the device is one or more of a computer, a redundant array of independent drives (RAID) device, a network interface, a hard disk drive, a graphics card, and a baseboard management controller.

16. The method of claim 8, wherein a baseboard management controller determines whether the installed firmware matches the firmware information.

17. A program product comprising a computer readable storage medium storing code executable by a processor to perform:
determining whether installed firmware for a device matches firmware information during a boot of the device, wherein the firmware information is stored at a specified storage location; and
mitigating a difference between the installed firmware and the firmware information.

18. The program product of claim 17, wherein mitigating the difference comprises:
identifying a firmware update; and
installing the firmware update.

19. The program product of claim 17, the code further recording the firmware information for each installation of a firmware image.

20. The program product of claim 17, wherein the specified storage location is one or more of a baseboard management controller storage location, a nonvolatile semiconductor storage location, a hard disk drive storage location, and a network allocated storage location.
